(19) United States
(12) Patent Application Publication
(10) Pub. No.: US 2016/0267607 A1
(43) Pub. Date: Sep. 15, 2016

(54) SYSTEM AND METHODS FOR PROVIDING GENERATING COMPENSATION INFORMATION FOR A DYNAMICALLY STRUCTURED ORGANIZATION

(71) Applicant: Philip Zepter, Monaco (MC)

(72) Inventor: Philip Zepter, Monaco (MC)

(21) Appl. No.: 15/067,207

(22) Filed: Mar. 11, 2016

Related U.S. Application Data
(60) Provisional application No. 62/131,916, filed on Mar. 12, 2015.

(51) Int. Cl. G06Q 40/00; G06Q 10/06; G06Q 10/10

(52) U.S. Cl. CPC G06Q 40/125; G06Q 10/105; G06Q 10/06398

(57) ABSTRACT

Systems and methods relate to systems and methods for generating providing compensation information for members of an organization. The organization may have a hierarchal structure and be regularly adjusted, based on compensation information. The members of the organization can be arranged in groups. Groups have managers with the manager compensation based on the group performance. Non-managerial member compensation may be based primarily on individual performance.

### RELATED APPLICATION(S)

This application claims priority to U.S. Provisional Patent Application No. 62/131,916, the contents of which are incorporated herein by reference in their entirety, for all purposes.

### TECHNICAL FIELD

Various embodiments relate to systems and methods for providing earnings information for members of a dynamic hierarchical organization.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an exemplary representation of an organization including with members arranged or position in a hierarchal-like structure in accordance with an exemplary embodiment of the present disclosure.

FIG. 2 is a schematic representation of a system operatively connected to one or more devices or systems according to an exemplary embodiment of the present disclosure;

FIG. 3 shows a schematic representation of a database system storing exemplary types of data according to an exemplary embodiment of the present disclosure.

FIG. 4 shows an exemplary flow chart illustrating a method for determining compensation information, payment information and organization change information for a dynamic hierarchal structure according to an exemplary embodiment of the present disclosure.

FIGS. 5A-7 show exemplary tables indicating information related to compensation information for members of arranged or position in a hierarchal-like structure in accordance with an exemplary embodiment of the present disclosure.

### SUMMARY

In accordance with exemplary embodiments, a method may include obtaining, by one or more computers, sales data and organizational data for a plurality of members of an organization, the sales data including data indicating amount of sales from at least currently invoiced sales contract accomplished by the members during one or more time periods, the organizational data including data indicating the ranking level of the members and groups to which the members belong; determining, by the one or more computers, projected compensation data for non-managerial members; determining, by the one or more computers, projected compensation data for managerial members; determining, by the one or more computers, payout or payment data for each of the members; determining, by the one or more computers, based on projected compensation data and organizational data, one or more changes to organization; and updating the organizational data based on the one or more determined changes to organization.

In an at least one exemplary embodiment, the organizational data may include data indicating the plurality of members of the organization in a hierarchal-like structure comprising one or more groups, with data including a ranking for of the members.

In an at least one exemplary embodiment, the organizational data may indicates, for each of the one or groups, at least one group manager, the group manager having one out of a plurality of managerial rankings and the group further comprising one or subordinate members having one out of a plurality of more ranking levels below the ranking level of the group manager. In one or more embodiments, the one or more computers may determine, based on projected compensation data and previous sale data, whether any member of the plurality of members is in active; and wherein in response for determining a member is inactive, modifying the organizational data by the one or more computers, the modifying can include: deleting the determined inactive member from the organizational data and rearranging subordinate members of the determined inactive member.

In exemplary embodiments, rearranging the subordinate members of the determined inactive member may include reassigning each of the subordinate members so that organizational indicates each subordinate member ranking level is increased by one ranking level.

In exemplary embodiments, methods and systems may include storing projected compensation data and the updated organizational data on one or more electronic databases stored on one or more non-transitory computer-readable storage media. In exemplary embodiments, determining the projected compensation data for each of non-managerial members can include determining whether a total amount of sales for each respective non-managerial member for a previous time period, determining a sales commission percentage associated with the determined total amount of sales for the respective non-managerial member, and applying the determined sales commission percentage to the determined total amount of sales.

In exemplary embodiments, determining projected compensation data for each of managerial members can include determining a total amount of sales from the manager's group for a previous time period, wherein the total amount of sales including the manager's sales for the previous time period, determining a managerial sales commission percentage associated with the determined total amount of sales for -managerial member, and applying the determined sales commission percentage to the determined total amount of sale, and applying the determined sales commission percentage to the determined total amount of sales for the manager's group.

In exemplary embodiments, the determined the sales commission percentage for the managerial commission may be based at least in part on a current or previous manager's group sales amount, the manager's current or previous personal sales amount, and a current or previous number of active subordinate members in the manager's group.

In exemplary embodiments, determining one or more changes to organization may include determining, from at least the organizational data, whether any new member is recruited, and further determining a commission for recruiter for the recruited member.

In exemplary embodiments, determining one or more changes to organization may include determining, based on obtained organizational data and sales data, and projected compensation data, whether a managerial ranking associated with each manager of the organization is to be changed.

In exemplary embodiments, methods and systems may further include determining a payout for one or more of the plurality of members of the organization. In exemplary embodiments, a determined payout may be based on a percentage of sales contracts that have been partially paid.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments. Various embodiments are described in connection with methods and various embodiments are described in connection with devices. However, it may be understood that embodiments described in connection with methods may similarly apply to the devices, and vice versa.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include any integer number greater than or equal to one, i.e. one, two, three, four, etc.

The term “a plurality” may be understood to include any integer number greater than or equal to two, i.e. two, three, four, five, etc.

The term “connection” may include both an indirect “connection” and a direct “connection”.

Elements of embodiments of the present disclosure may be embodied in hardware, firmware and/or software. While exemplary embodiments revealed herein may only describe one of these forms, it is to be understood that one skilled in the art would be able to effectuate these elements in any of these forms while resting within the scope of the present disclosure.

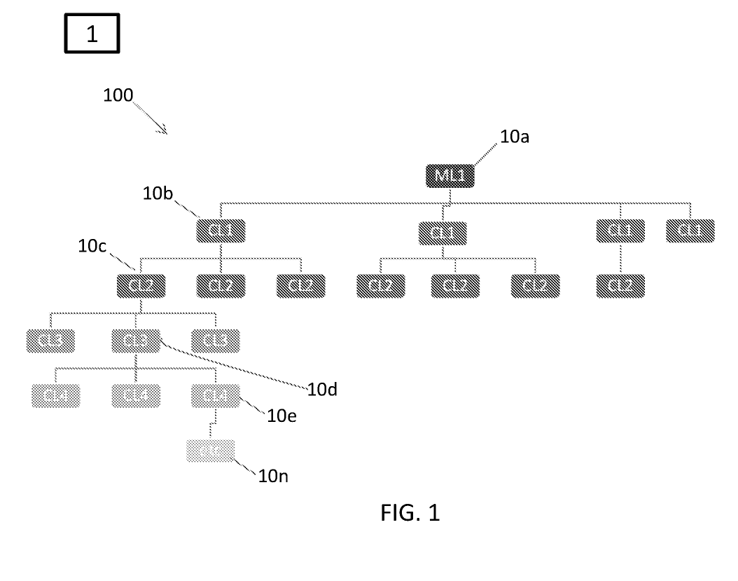

In various with exemplary embodiments of the present disclosure may relate to generating compensation and organization change data for members of an organization 1 and which may be described with reference to FIG. 1.

FIG. 1 shows members 10 of an organization 1 within a group 100. The group 100 of the organization 1 has a hierarchal structure. In exemplary embodiments, an organization 1 may have one or a plurality of groups similar to group 100. As shown, the members 10 of the group 100 may be assigned to a certain ranking or position. The group 100 may include at the at least one superior or top member 10a, e.g., a group leader or manager. In this case the manager may be designated or identified with an exemplary ranking of ML1. Rank-wise, below or underneath the member 10a or the ML1, may be one or more members at another, lower level. As shown in FIG. 1, shows some members immediately below the member 10a having a ranking of CL1. The shown members with the CL1 ranking are subordinate to member 10a. The members with the CL1 ranking or with a lower ranking (e.g., CL2, CL3, etc.) can also have one more subordinate members, but this is not necessary. In FIG. 1, the member 10b which is a member with the CL1 ranking or level has subordinate members. The member 10c at ranking CL2, which is shown as a direct subordinate of member 10b and an indirect subordinate to member 10a, is also shown as having three direct subordinate member 10s at CL3, three subordinate member 10s at CL4, and so on. The other member 10s at the ranking CL2 are shown in as not having any subordinate member 10s. In exemplary embodiments, there is no set limit to as the amount of levels. For example

In accordance with exemplary embodiments of the present disclosure, systems and methods are disclosed for generating or providing compensation data and organization 1al change data for member 10s of an organization 1 having one or more dynamic hierarchal groups, such as shown in FIG. 1. A dynamic hierarchal group may be a group, within in any organization (e.g., company) with members arranged in a hierarchal structure that is or can be regularly or periodically rearranged.

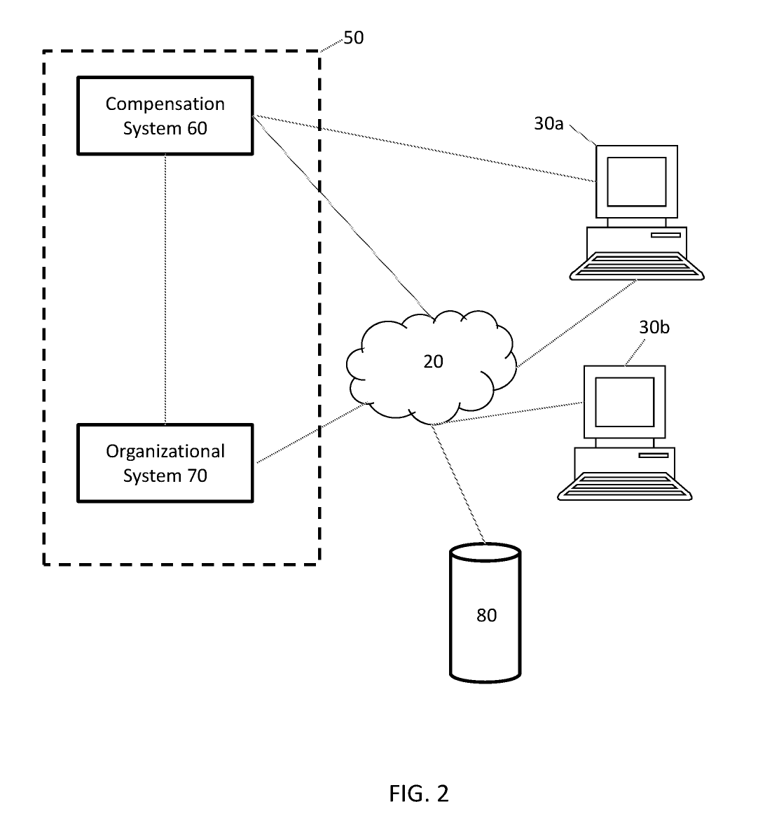

FIG. 2 shows an exemplary system 50 operatively connected to one or more devices or other systems for generating or providing compensation data and organization adjustment data for an organziation having a dynamic hierarchal structure in accordance with exemplary embodiments of the present disclosure. As shown, the system 50 may include one or more subsystems, including, for example, a compensation system 60 and an organization system 70.

The compensation system 60 may generate and/or manage data indicating, reflecting, or related to compensation of member 10s of an organization 1, in particular to an organization 1 involved in sales. For example the compensation system 60 may access data regarding an organization 1 structure, sales data, (e.g., sales data for individual member 10s, the groups the member 10s belong to, etc.). Additionally, the compensation system 60 may include and/or access rules regarding or indicating how compensation is to be determined/calculated for the members 10 of the organization 1. Generally, the compensation of a particular member 10 may be based on several factors, such as a member's ranking or level within an organization 1, or a group thereof, an amount of revenue (e.g., sales) produced or generated by the member 10, the group the member belongs to, and other relevant factors or considerations.

In other words, the compensation engine 30 may process sales data, organization data, and/or rules data to determine compensation for members 10 of an organization 1. The compensation engine 30 may also determine compensation for one or more subsets e.g., groups, of the organization 1. This compensation may be determined or calculated for over various times. The time can be expressed in various and any suitable formats, including for example cyclical times, time periods or intervals, dates, etc. and the like. In one example, the compensation may be determined on a monthly basis for at least some of members 10 or groups of the organization 1.

The organization system 70 may generate and/or manage data that indicates or relates to the structural arrangement of the member 10s of the organization 1. The organization system 70 may determine and/or implement changes to an organization 1. That is, the organization system 70 may process or operate on data related or reflecting the organization structure of the organization 1, and can manipulate or change the data based on several factors, including sales data, member 10 repositions and other changes (e.g., addition or deletion of member 10 from organization 1), and the like. The manipulation of the structural data may be automatic or may be contingent on approval from one or more authorized member 10s.

Each of the compensation system 60 and the organization system 70, or other components shown in FIG. 2, may include one or more computing devices (e.g., computer, server, tablet, mobile device, etc.). Such computing devices or processors thereof may execute software stored on and/or accessed from any suitable non-volatile (e.g., non-transitory) computer readable storage media. While the compensation system 60 and the organizational system 70, are depicted as separate entities, one or more of these components may be combined or implemented together on the same one or more computing devices, or separately. If implemented separately, these components may be directly connected to each other, or indirectly connected to each other through one or more intermediary networks (e.g., Internet, Intranets, etc. designated by reference numeral 20). Alternatively, the entities may reside or implemented as one or more software entities on one or more common or shared computing devices.

Each of the compensation system 60 and the organization 1al system 70 may also include or operatively connected to one or more databases, collectively represented as database 80. That is, while the database 80 is illustrated as a single component, this merely exemplary and not meant to be limitation. In some exemplary embodiments, the database 80 can include one or more database systems which may be located locally and/or remotely and operatively connected to the other components. Any suitable database systems or formats may be used, wherein the various data/information may be subdivided and managed into one or more databases, tables, etc. as is appropriate in accordance with embodiments described herein.

As show in FIG. 2, the compensation system 60 and the organization 1al system 70 may be operatively connected to one or more computing devices computers collectively or individually designated by 30 (30a . . . 30N). The computing devices 30 may be used for obtaining, collecting, providing data, or regarding various aspects of an organization, e.g., business and personnel related data and may interface with the database 80. For example, the computing devices 30 may be part of the system 50 and may be implemented or used to receive or obtain data regarding sales contract, that is collecting invoiced sales data, in one example.

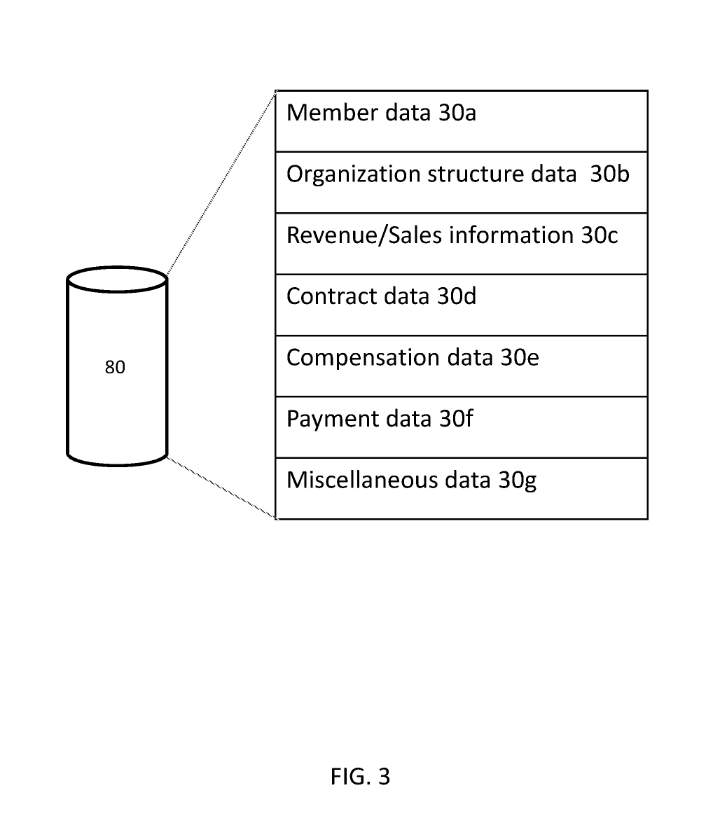

According to an exemplary embodiment of the present disclosure, FIG. 3 discloses type of data that may be stored in and managed by the database 80. That is, the database 80 may include member data 30a, organization structure data 30b, sales information 30c, contract data 30d, compensation data 30e, payment data 30f, and miscellaneous data 30g. The member 10 data 30a may include personnel information related to members 10 of the organization 1, including, for example, information about the member 10's ranking or level within the organization 1. The organization 1 structure data 30b may include information regarding how the members 10 are organized or related. The sales information 30c may include information related to sales for one or more time periods, and can further include recent or current sales accomplished by the members 10 of the organization 1. The contract data 30d may include information related to contractual obligations, for example details from invoiced sales procured members 10 and further data related to whether requirements of a contracted sales has been implemented, e.g., payments, cancellations, delivering of products or services to contracting clients/customers.

The compensation data 30e may include information related to the amount of compensation a member 10 had or may receive. The payment data 30f may include information about how and when a member 10 is to be compensated or in other words, what payments the members 10 have received or are scheduled to receive. The miscellaneous data 30g may include information needed any other needed or suitable data to realize the methods and systems described herein.

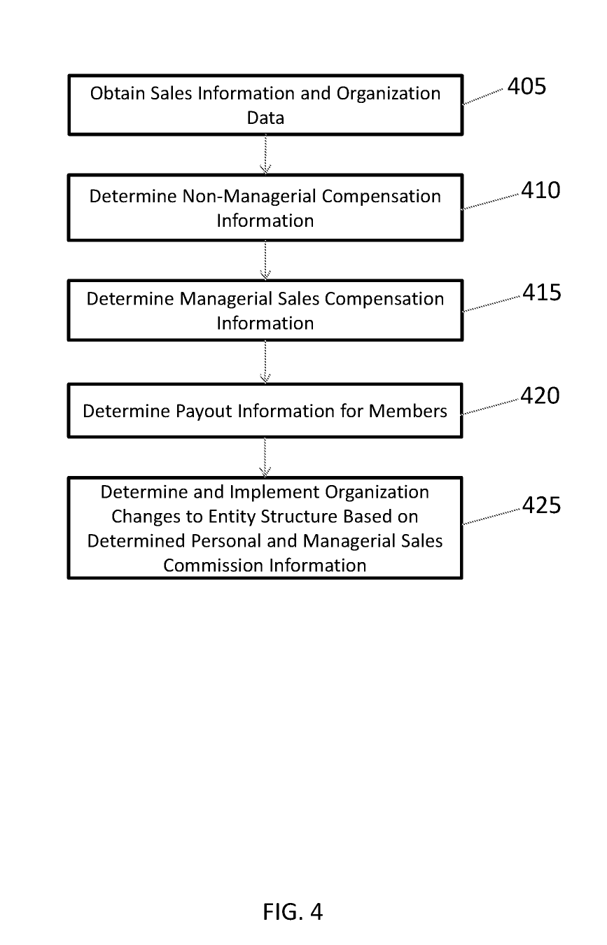

FIG. 4 shows a flow chart illustrating a method for generating compensation and organization data in an organization, for example an organization with a dynamic hierarchal structure. In one or more embodiments, the organization 1 may include members 10 that are compensated, based at least in part on a determined/calculated commission of generated revenue or sales.

At step 405, one or more computers may obtain sales organizational information. The one or more computers may be associated with the one or more subsystems (compensation system 60 and organization 1 system 70). The sales information may be obtained and stored in the database 80. The revenue or sales information may be data or records of sales achieved by the members 10 of the organization 1. In embodiments, the obtained sales information may include total sales for each member for at least a current time period, e.g., last month, last quarter, etc, as well as for other desired time periods. Additionally, organizational data may be obtained, with the data indicating which member 10s are in which group with what particular ranking.

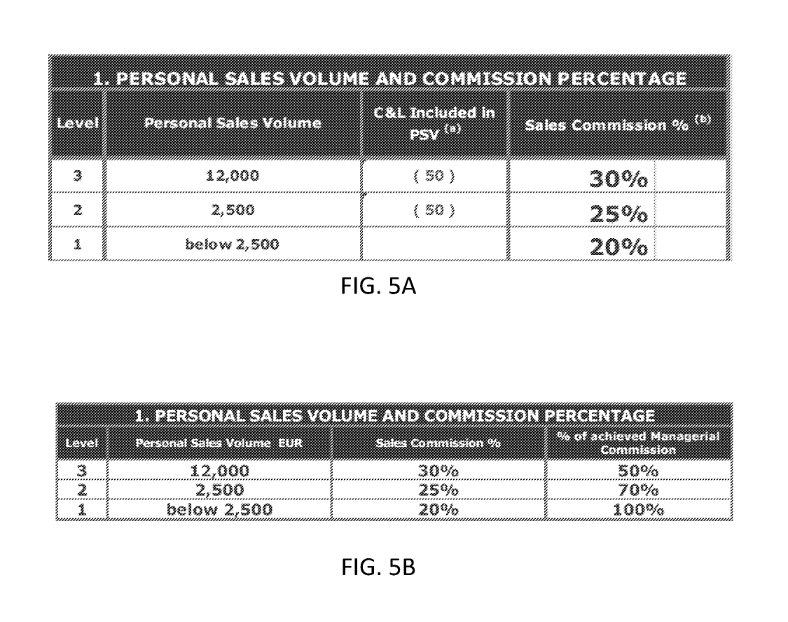

After obtaining the sales information, at 410 compensation or projected compensation data for non-manager members 10 may be determined. For example, referring to FIG. 1, non-manager member 10s may rankings or levels of CL1, C2, C3, etc. The compensation structure for each respective member may be determined based on several factors, including a total amount of revenue or sales the respective member 10 generates, which may be named personal sales volume (PSV). The compensation can also be based on the ranking of the respective member 10. In exemplary embodiments, the compensation may be at least partially commission-based with each respective member 10's commission dependent upon how many sales the member 10 generates and may depend on the amount of revenue/sales in one or more specific product/service categories, for example cosmetics and luxury products (C&L), in one example. The table of the exemplary embodiment of FIG. 5 shows different levels of sales commissions that may be achieved for members 10. For each of these levels, the corresponding minimum personal sales volume and the minimum amount of C&L sales needed to be reached in order to receive the specified sales commission percentage is specified. For example, to reach the sales commission of level 3, which is 30%, a member 10 needs to have a PSV for a time period (e.g., a month) of 12,000 (specified in euros) and have at least 50 (euros) in C&L product sales. If a member 10 does not reach such targets or threshold, the member 10 will drop at least one level in commission levels. That is, if a member 10 does not reach the targets for a level 3 commission, the member 10 may reach have a level 2 sales commission percentage of 25% provided the member 10 has at least 2,500 [symbol] in PSV and 50 [symbol] in C&L product sales for the given time period. Otherwise the member 10 would only be entitled to a sales commission of 20%, at level 1.

Additionally, there may be other factors to consider and used by the compensation system 70. In some exemplary embodiments, a member 10 that recruits a new member 10 to join the organization, may be entitled to a “recruitment commission”, which may be determined as a percentage of the PSV of the newly recruited member 10 for a limited time period. In one example, a member 10 who recruits a new member 10 may be entitled to receive 5% of the newly recruited member 10's PSV for three months.

In some embodiments, a recommending member 10 or a “recruiter” may continue to a commission of the recruited member 10's PSV if recruited member 10's PSV meets a minimum threshold amount, such as 1000 [symbol] in one example.

After determining projected compensation for non-managerial members 10, projected compensation for managerial members 10 is determined at 415. In exemplary embodiments, in order to a manager's projected compensation, the respective group sales volume for each respective manager's group is determined. The manager group sales volume (“GSV”) may be the total or sum of the manager's own PSV and the PSV of all subordinate members 10 to the manager. The managerial sales commission is determined, based on a current managerial ranking, the manager's PSV and the GSV of the manager's group.

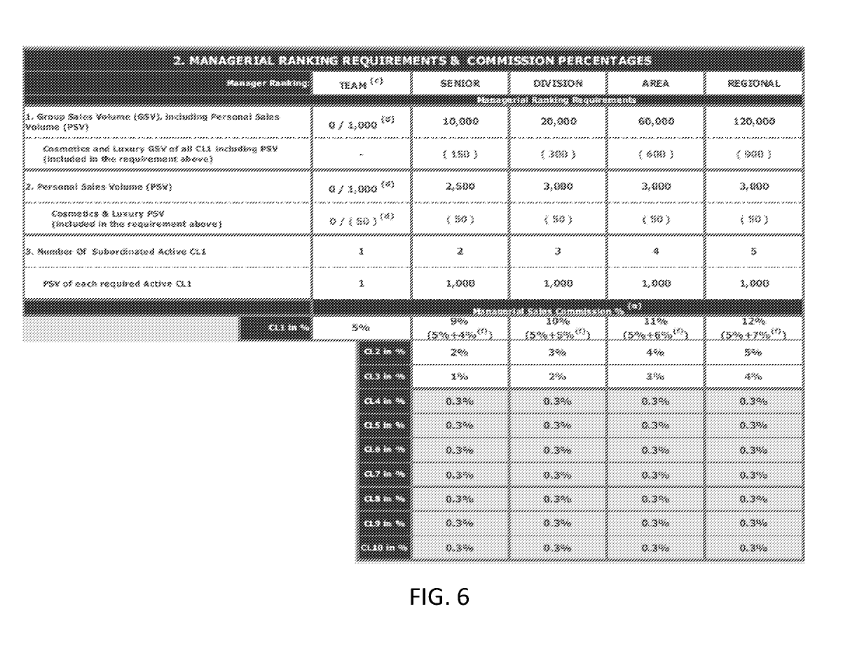

In exemplary embodiments, a managerial ranking of the of the manager member 10 may be based revenue or sales from one or more previous times or time periods. FIG. 6 shows, according to at least one exemplary embodiment, a table indicating the requirements for obtaining or maintaining different managerial rankings or levels. For example, in order for a manager to have a “Region” managerial ranking, the manager is required to have 1) a GSV of at least 120,000 euros, at least 900 euros of which has to be in C&L(cosmetics and luxury) products, 2) at least 3,000 euros in PSV with at least 50 of which has to be in C&L products, and 3) must have at least five (5) subordinate member 10s that a ranking of CL1, with each of these CL1 subordinate member 10s being active (e.g., currently having sales) and having a PSV of at least 1,000 euros. These requirements, for example, may be obtained in the previous time period, for example the previous month. Similarly, for a manager to obtain a ranking of “Area”, the manager must have 1), 60,000 euros in GSV with at least 600 euros in C&L products, 2) a PSV of at least 3,000 euros with at least 50 euros in C&L, and 3) at least 4 CL1 member 10s each having at least 1000 euros in PSV. By contrast, the for a manager to obtain the lowest manager ranking of “Team”, the manager needs 1) a GSV of 1,000 euros, 2) a PSV of 1000 euros with at least 50 in C&L products, and 3) 1 active CL1 subordinate member 10 with no minimum PSV requirement. These figures and including the money in euros is merely exemplary.

In the exemplary embodiment of FIG. 6, a lower half of the table indicates the corresponding compensation or commission for a manager of each of the exemplary managerial rankings. According to FIG. 6, a manager with a “Team” ranking is entitled to a base 5% commission of the PSV of Team manager's subordinate CL1 member. A manager with a “Senior Ranking” is entitled to at least a 9% commission, that is a Senior manager is entitled to a base 5% commission and an additional 4% commission from the Senior manager's subordinate CL1 member 10s. Additionally, the table shows a Senior manager is also entitled to a commission from lower subordinate manager, such as 2% commission of the PSV of each of the Senior manager's CL2 member 10s and 1% commission of the PSV of each of the Senior manager's CL3. For each member 10 of the Senior manager's group with a ranking below CL3 (e.g., CL4, CL5, CL6, etc.), the Senior manager is entitled to 0.3% commission of the PSV for each of these member 10s.

The exemplary table of FIG. 6 shows the corresponding managerial commission percentages for managers having other rankings, e.g., Division, Area, and Regional.

As previously mentioned, a member 10, e.g., a manager or non-manager can recruit or recommend a new person to join as a member 10 of another group of the organization. The recruiter or recommender can receive a percentage of the recruited member 10's PSV. In some embodiments, the recommender may receive the same commission for example, 5%, of the recruited member 10's PSV for a given period, such as, three months in one example. The recruiter or recommending member 10 may continue to receive this commission of the recruited member 10 maintains a PSV above a certain threshold, such as 1000 euros of PSV in one example. However, in some embodiments, the PSV of the recruited or recommended member 10 may not count in a calculation of the GSV of a recruiter that is a manager, own GSV, since the recruited member 10 is in another group.

As previously discussed with respect to FIG. 5A, there may be different levels of sales commissions that may be achieved for members 10 depending on whether a PSV of a member 10 reaches certain thresholds or amounts. As discussed, a member 10's PSV factors into a calculation of associated manager's commission. In accordance with exemplary embodiments, the level of sales a member 10 achieves, e.g. level 3, level 2, or level 1, may be used by the compensation system 10. That is, the member 10's PSV may be “discounted” in the manager's GSV calculation. For example, in the exemplary embodiment of FIG. 5B, the table indicates how much of a member 10's PSV is counted towards the managerial commission. For example, if a member 10 is in level 1, the member's sales are counted 100% towards in one or more calculations, such as GSV, related to the manager's commission. In other situations, if the member 10 has sales placing the member in level 2, the member's 10 sales may only count 70% towards the managerial commission, and if the member 10 has sales placing the member in level 3, the member's 10 sales may count 50% towards the managerial commission.

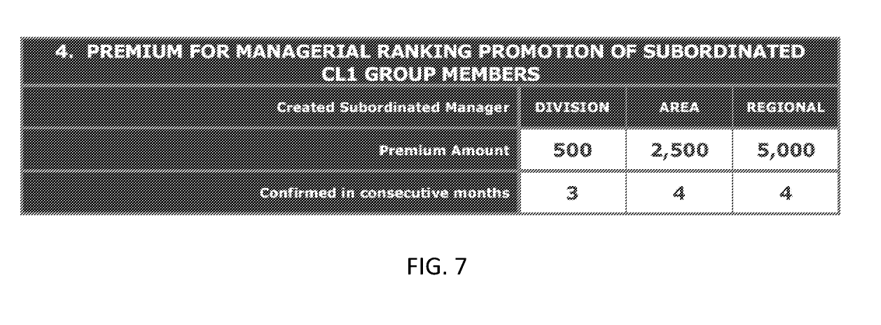

Additionally, a manager or member 10 with ML1 ranking or above (e.g., ML2, ML3, etc.) may also be entitled to bonus if a member 10, such as a member 10 with CL1 ranking “graduates” or is promoted to a manager with a ML1 ranking or above. That is, if the CL1 is able to maintain the newly obtained ML1 ranking for a certain period of time, e.g. 3 or 4 months, the manager of the advancing member 10 could be entitled to a bonus. The exemplary embodiment of FIG. 7 shows a table indicating an exemplary bonus/premium structure for members 10 that have a subordinate member 10 that has advanced or is promoted to a manager. For example, a member 10 that has a subordinate member 10 that advances to a division manager and maintains the division manager ranking for 3 consecutive months can receive a 500 euro bonus. In embodiments, a condition to receive the premium may also be contingent on the manager maintaining his ranking despite absence of the advancing subordinate member 10 from the manager's group due to the promotion. In exemplary embodiments, a member 10 may be entitled to the bonus or premium only once for an advancing subordinate member 10.

Referring back to FIG. 4, after determining compensation information for managers and non-managers, at 420, payout or payment information may be determined and stored. This information may relate to how much and when payments are to be made to members. Accordingly to exemplary embodiments, the compensation system 50 may be responsible for determining the compensation for the members 10 of a dynamic hierarchal organization. The commissions described herein may be considered projected compensation, that is, they may be at least partially contingent on received payment from customer/client. The sales, that member l Os may generate may be invoiced sales that have not yet be considered finalized, at least for compensation purposes, until adequate or sufficient payment (e.g., at least partial payment) is received from an agreeing customer/client. The compensation system 50 may also be responsible for determining and/or scheduling payments, advances, or credits to the members 10. The system 70 may electronically receive and/or store information regarding payment to sales contract, as needed. Data form an invoiced sales may need to be registered within a time period, e.g., 30 days. For example the contract information may be electronically input into a computer associated with the compensation system 50 and stored in the database 80.

In one exemplary embodiment, the compensation system 50 may schedule a payout to members 10 based on received payments, such as for example, partial payments. For example, a non-managing member 10 may be scheduled to receive an advance payout equal to 70% of each partial payment, up to 80% of the commission to be paid out. A manager may receive a corresponding advance payout equal to 20% of each partial payment, up to 80% of the commission to be paid out. Partial payments, may only qualify for consideration, if they are at least a minimum amount (e.g., 30%) of the contracted sales amount and are paid within a given time frame or period. In other words, for each received net partial contracted payment, credit 70% will automatically be credited to the non-managing member 10 and 20% to the associated manager. The remaining 20% will be paid after the contract is fully paid and, if necessary after the member 10 assists or fulfills any other contractual duties to a customer, such as help a customer to put a product to use and at the same time conduct product consultation. This information, as previously mentioned, may be obtained and stored electronically.

In accordance with exemplary embodiments, the compensation system 50 may adjust compensation and payment information in the event of contract cancellation. For example, after a contract for sales with a customer has been signed, there may be a cancellation by the customer. Therefore, in at least one embodiment, if a customer cancels a contract but has paid the full cancellation fee (which may be a percentage of the contracted value), the member 10 associated with the contract may be eligible or titled to a percentage (e.g. 50%) of the whole Gross Personal Sales Commission. If member 10 has already received advances/credits which are higher than 50%, then the compensation system 60 will arrange and indicate that the difference will be paid back to the organization. For example, future payments or payouts may be appropriately adjusted (e.g., reduced).

In exemplary embodiments, a managing member 10 may not have the right to receive any commission if there is a cancellation and the cancellation fee is not paid in full.

In exemplary embodiments, if a customer who has contractually agreed to a sale but pays less than the cancellation fee, the associated member 10s have no right to any commission and with the compensation system 60 arranging so they refund the whole advance/credit to the organization.

After determination of compensation and payout information, at 425 the organizational system 70 may determine changes to the organization, or organizational structure and may generate or update existing information to that effect.

In at least one embodiment, the organizational system 70 may modify organizational data in response to detected changes, e.g., through received electronic data. For example, a person may join or be recruited to join an existing group. Data may be obtained reflecting this change. An existing member may recruit a new person, for example to be a subordinate member. For example, if a person is at the CL2 level, a new recruited member may become a member with the CL3 ranking. In other embodiments or situations, a member may recruit a new member to be at the same level as the recruiter, for example a recruiter may be at the CL1 level and recruit another person to join a group with a CL1 ranking.

Furthermore, a recruitment may result in the recruiter being promoted or advanced within the organizational structure. That is, in exemplary embodiments, a recruiter can be promoted and/or paid as having a managerial ranking, and thus for at least a limited time, e.g., three months, starting from the first month of initial recruitment, if the recruiter reaches a certain threshold of PSV (for example of 2,500 euros) and the recruited member is active and with a minimum PSV, e.g., 1000 euros in PSV.

In some embodiments, the organizational system 70 may determine from received input or organizational data that a member is to “break away” from an existing group so as to form a new group or be added to another group. For example, there may be a rule, specifying that if a member at the CL1 ranking is responsible for more than 66% of a GSV of a group for 3 consecutive months, then this CL1 member along with the CL1 member's subordinate members break away to form a new group or in some embodiments, join another group. The managerial commission of the team manager of the group that losing the CL1 member (and its subordinate members), will no longer be based on the leaving CL1 member and the CL1 member's subordinate members future PSVs. A member that recruited the break-away CL1 member can continue to have a recommending commission based on the break-away CL1 member. Accordingly, the organizational system 70 that determines the existence of conditions for such changes may update the information in the database 80 to indicate or reflect such changes for future processing.

In an exemplary embodiment, the organizational system 70 may effect changes in response to detecting or determining when a manager fails to achieve the requirement associated with the managerial ranking, for one or more time periods. In one example, if a manager or ML1 member fails to achieve a Senor Ranking in any consecutive 3 month period, all the subordinate CL1 members of the ML1 member's group and be assigned or added to a superior manager of the ML1 member, designated, for example as ML2 in one example. In such a scenario, the superior manager, for example a manager with a ML2 ranking or above, becomes the new manager for the breakaway group for future compensation purposes. The ML1 member that lost the breakaway group may receive a recruitment commission on the PSVs of the breakaway CL1 members.

In exemplary embodiments, the organizational system 70 may respond to the after detecting other events, conditions, or developments and make changes to the organizational data to reflect organizational changes. For example the organizational system 70 may determine if members are active or inactive. In some embodiments, the organizational system 70 determines a CL1 member reaches an inactive status if the CL1 member is inactive, e.g., no sales for a certain time period. For example, if a CL1 member has no sales for three consecutive months, the organizational system 70 will update the information in the database 80 to indicate such a member is in active and delete him from the organizational structure. The organizational system 70 can update information in the database 80 to indicate that contractual agreement(s) between the inactive member and the organization is terminated. Other members, members of the organization with other rankings may be similarly terminated in response to a prolonged inactivity period.

In exemplary embodiments, in response to the organizational system 70 detecting a member is to be terminated, re-rearranges the corresponding organizational data. In some embodiments, the organizational system 70 will advance the subordinate members of the terminated or to be terminated member upward one level. For example, if a CL1 member is terminated, the corresponding subordinate members at the CL2 level will be promoted or advanced to the CL1 level, members at the CL3 level will be advanced to CL2 level, and so on.

In accordance with exemplary embodiments, the organization system 70 may be a applied to groups having a different organizational structure.

In accordance with various exemplary embodiments presented herein, compensation information including commission calculations may be based only on net invoiced prices.

Members of the organization, may be are family members and/or close relatives (spouses, parents, children, brothers, sisters, etc.).

In accordance with various exemplary embodiments presented herein, new member(s) may be added to the organization and new member information may be electrically obtained from one or more computers or the like.

While the process of FIG. 4 is shown in a particular order, this is not necessarily so. The steps or process events of FIG. 4 may occur in any suitable order while still in the spirit of the disclosures presented herein. Furthermore, other steps may be included, including the obtainment of any information described herein that was not specifically mentioned with regard to a particular step or embodiment. For example, one or more steps may involve the obtainment of payment information from clients that have agreed to buy products.

The data or type of data shown or indicated from the tables of FIGS. 5A-7, may be stored in any appropriate location, such as the database system 80 and accessed by any of the components referred to herein such as the components shown in FIG. 2.

While various aspects of this disclosure have been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A method comprising:
obtaining, by one or more computers, sales data and organizational data for a plurality of members of an organization, the sales data comprising data indicating amount of sales from at least currently invoiced sales contract accomplished by the members during one or more time periods, the organizational data comprising data indicating the ranking level of the members and groups to which the members belong;
determining, by the one or more computers, projected compensation data for non- managerial members;
determining, by the one or more computers, projected compensation data for managerial members;
determining, by the one or more computers, payout or payment data for each of the members;
determining, by the one or more computers, based on projected compensation data and organizational data, one or more changes to organization; and
updating the organizational data based on the one or more determined changes to organization.

2. The method of claim 1, wherein organizational data comprises data indicating the plurality of members of the organization in a hierarchal-like structure comprising one or more groups, with data including a ranking for of the members.

3. The method of claim 1, wherein organizational data further indicates, for each of the one or groups, at least one group manager, the group manager having one out of a plurality of managerial rankings and the group further comprising one or subordinate members having one out of a plurality of more ranking levels below the ranking level of the group manager.

4. The method of claim 3, further comprising:
determining, by the one or more computers, based on projected compensation data and previous sale data whether any member of the plurality of members is in active; and
wherein in response for determining a member is inactive, modifying the organizational data by the one or more computers, the modifying comprising:
deleting the determined inactive member from the organizational data and rearranging subordinate members of the determined inactive member.

5. The method of claim 4, wherein rearranging the subordinate members of the determined inactive member comprising reassigning each of the subordinate members so that organizational indicates each subordinate member ranking level is increased by one ranking level.

6. The method of claim 1, further comprising storing the projected compensation data and the updated organizational data on one or more electronic databases stored on one or more non-transitory computer-readable storage media.

7. The method of claim 1, wherein determining the projected compensation data for each of non-managerial members comprises,
determining whether a total amount of sales for each respective non-managerial member for a previous time period,
determining a sales commission percentage associated with the determined total amount of sales for the respective non-managerial member,
applying the determined sales commission percentage to the determined total amount of sales.

8. The method of claim 7, wherein determining the projected compensation data for each of managerial members comprises,
determining a total amount of sales from the manager's group for a previous time period, wherein the total amount of sales including the manager's sales for the previous time period,
determining a managerial sales commission percentage associated with the determined total amount of sales for -managerial member,
applying the determined sales commission percentage to the determined total amount of sale,
applying the determined sales commission percentage to the determined total amount of sales for the manager's group.

9. The method of claim 8, wherein the determined the sales commission percentage for the managerial commission is based at least in part on a current or previous manager's group sales amount, the manager's current or previous personal sales amount, and a current or previous number of active subordinate members in the manager's group.

10. The method of claim 1, wherein determining one or more changes to organization comprises determining, from at least the organizational data, whether any new member is recruited, and further determining a commission for recruiter for the recruited member.

11. The method of claim 1, wherein determining one or more changes to organization comprises determining, based on obtained organizational data and sales data, and projected compensation data, whether a managerial ranking associated with each manager of the organization is to be changed.

12. The method of claim 1, further comprising:
determining a payout for one or more of the plurality of members of the organization.

13. The method of claim 12, wherein the determined payout is based on a percentage of sales contract that have been partially paid.
